(19) United States
(12) Patent Application Publication
(10) Pub. No.: US 2026/0067561 A1
(43) Pub. Date: Mar. 5, 2026

(54) OCCLUSION JUDGMENT SYSTEM, OCCLUSION JUDGMENT METHOD, COMPUTER READABLE RECORDING MEDIUM WITH STORED PROGRAM, AND NON-TRANSITORY COMPUTER PROGRAM PRODUCT

(71) Applicant: REALTEK SEMICONDUCTOR CORP., Hsinchu (TW)

(72) Inventors: Chi-Jung Chen, Hsinchu (TW); Wen-Tsung Huang, Hsinchu (TW); Hung-Ju Liao, Hsinchu (TW)

(73) Assignee: REALTEK SEMICONDUCTOR CORP., Hsinchu (TW)

(21) Appl. No.: 19/238,844

(22) Filed: Jun. 16, 2025

(30) Foreign Application Priority Data
Aug. 28, 2024 (TW) 113132443

(51) Int. Cl. H04N 23/60; G06V 10/26; G06V 10/28; G06V 10/82; H04N 23/61

(52) U.S. Cl. CPC H04N 23/64; G06V 10/273; G06V 10/28; G06V 10/82; H04N 23/61

(57) ABSTRACT

An occlusion judgment system, an occlusion judgment method, a computer readable recording medium with a stored program, and a non-transitory computer program product are provided. The occlusion judgment system includes: a pre-processing unit configured to receive an image from a lens and perform a pre-processing procedure on the image to obtain a pre-processed image; a depth image generating unit configured to perform a depth image computation procedure on the pre-processed image to obtain a depth image; and a judgment unit configured to determine a lens state of the lens based on the depth image.

### CROSS-REFERENCE TO RELATED APPLICATION

This non-provisional application claims priority under 35 U.S.C. § 119(a) to Patent Application No. 113132443 filed in Taiwan, R.O.C. on Aug. 28, 2024, the entire contents of which are hereby incorporated by reference.

### BACKGROUND

### Technical Field

The disclosure relates to techniques for determining whether a lens is occluded, and in particular to a technique for determining whether a lens is occluded by using an image captured by the lens.

### Related Art

Nowadays, notebook computers or other devices that contain an imaging apparatus are equipped a lens hood because they are designed with the user's privacy and security in mind. The lens hood can prevent unauthorized remote photography or surveillance to protect privacy when the camera is not in use. In order to further remind the user, a function of determining whether the lens is occluded is needed. The purpose of this function is to remind the user to open the hood when using the camera. However, there may be misjudgment in some cases. For example, in a dark environment, there may be the misjudgment that the lens is occluded, which may cause the system to issue a wrong reminder. This often bothers the users because they are misled into thinking that the camera lens is occluded when it is not.

### SUMMARY

In view of this, some embodiments of the disclosure provide an occlusion judgment system, an occlusion judgment method, a computer readable recording medium with a stored program, and a non-transitory computer program product to alleviate the problems in the prior art.

Some embodiments of the disclosure provide an occlusion judgment system, including a pre-processing unit, a depth image generating unit and a judgment unit. The pre-processing unit is configured to receive an image from a lens and perform a pre-processing procedure on the image to obtain a pre-processed image. The depth image generating unit is configured to perform a depth image computation procedure on the pre-processed image to obtain a depth image. The judgment unit is configured to determine a lens state of the lens based on the depth image.

Some embodiments of the disclosure provide an occlusion judgment method, including: receiving, by a pre-processing unit, an image from a lens, and performing a pre-processing procedure on the image to obtain a pre-processed image; performing, by a depth image generating unit, a depth image computation procedure on the pre-processed image to obtain a depth image; and determining, by a judgment unit, a lens state of the lens based on the depth image.

Some embodiments of the disclosure provide a computer readable medium with a stored program and a non-transitory computer program product. A processing unit, after loading and executing the program, can complete the above occlusion judgment method.

Based on the above, some embodiments of the disclosure provide the occlusion judgment system, the occlusion judgment method, the computer readable recording medium with a stored program, and the non-transitory computer program product. The lens state of the lens is determined through the depth image of the pre-processed image. Since the depth image varies greatly in different environments, the lens state in a dark environment can be effectively prevented from being misjudged as an occluded state, so that the lens state can be determined more accurately.

### BRIEF DESCRIPTION OF THE DRAWINGS

FIG. 1 is a block diagram of an occlusion judgment system according to some embodiments of the disclosure;

FIG. 2A is a diagram of a low light source image according to some embodiments of the disclosure;

FIG. 2B is a diagram of a pre-processed image according to some embodiments of the disclosure;

FIG. 3 is a diagram of histogram equalization according to some embodiments of the disclosure;

FIG. 4A is a diagram of a pre-processed image according to some embodiments of the disclosure;

FIG. 4B is a diagram of a depth image according to some embodiments of the disclosure;

FIG. 5A is a diagram of a pre-processed image according to some embodiments of the disclosure;

FIG. 5B is a diagram of a depth image according to some embodiments of the disclosure;

FIG. 6 is a block diagram of an electronic system according to some embodiments of the disclosure;

FIG. 7 is a structural diagram of an electronic device according to some embodiments of the disclosure;

FIG. 8 is a flowchart of an occlusion judgment method according to some embodiments of the disclosure;

FIG. 9 is a flowchart of a depth image computation procedure according to some embodiments of the disclosure;

FIG. 10 is a flowchart of the occlusion judgment method according to some embodiments of the disclosure; and

FIG. 11 is a flowchart of the occlusion judgment method according to some embodiments of the disclosure.

### DETAILED DESCRIPTION

The above and other technical contents, features and efficacies of the disclosure will be clearly presented in the following detailed description of embodiments with reference to the drawings. Any modification and change that does not affect the efficacies and objectives of the disclosure shall still fall within the scope of the technical contents disclosed in the disclosure.

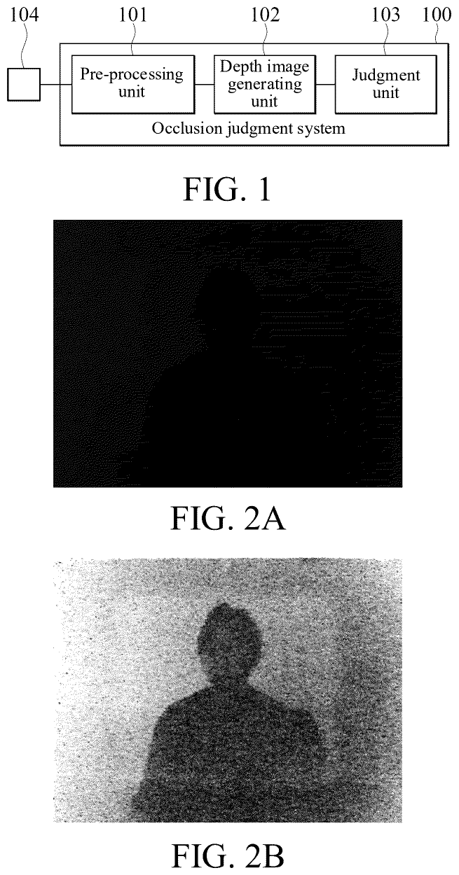

FIG. 1 is a block diagram of an occlusion judgment system according to some embodiments of the disclosure. FIG. 2A is a diagram of a low light source image according to some embodiments of the disclosure. Referring to FIG. 1 and FIG. 2A together, the occlusion judgment system 100 includes a pre-processing unit 101, a depth image generating unit 102 and a judgment unit 103. The pre-processing unit 101 is configured to receive an image 104 captured by a lens. The image 104 may be a grayscale image or a color image. The image 104 is, for example, a low light source grayscale image as shown in FIG. 2A. Since the contrast between objects and its background in a low light source image is generally low and the features of the environment in the low light source image are fuzzy, it is very likely to cause misjudgment when determining the lens state (including an occluded state and an unoccluded state) of the lens directly based on the low light source image. The pre-processing unit 101 is configured to perform a pre-processing procedure on the image 104 to highlight features of the environment in the image 104. After performing the pre-processing procedure, the pre-processing unit 101 outputs a pre-processed image corresponding to the image 104.

The occlusion judgment method according to some embodiments of the disclosure and how modules of the occlusion judgment system 100 cooperate with each other will be described in detail below with reference to the drawings.

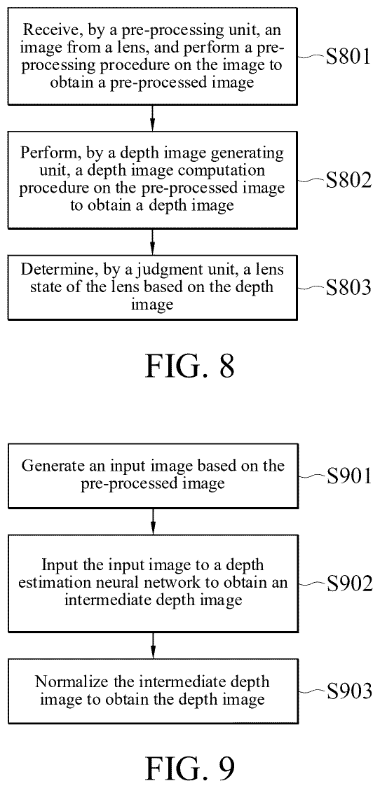

FIG. 8 is a flowchart of an occlusion judgment method according to some embodiments of the disclosure. Referring to FIG. 1 and FIG. 8, in the example of FIG. 8, the occlusion judgment method includes step S801 to step S803. In step S801, the pre-processing unit 101 receives an image 104 captured by a lens and performs a pre-processing procedure on the image 104 to obtain a pre-processed image. In step S802, the depth image generating unit 102 performs a depth image computation procedure on the pre-processed image to obtain a depth image. In step S803, the judgment unit 103 determines a lens state of the lens based on the depth image.

FIG. 2B is a diagram of a pre-processed image according to some embodiments of the disclosure. In some embodiments of the disclosure, the image 104 is a grayscale image, and the above pre-processing procedure includes carrying out histogram equalization on the image 104. Carrying out histogram equalization on the image 104 can improve the overall contrast of the image 104 and strengthen the features of the image 104. Referring to FIG. 2B, the pre-processing unit 101 carries out the histogram equalization on FIG. 2A to obtain the pre-processed image FIG. 2B of FIG. 2A. As shown in FIG. 2B, the features of FIG. 2A are strengthened.

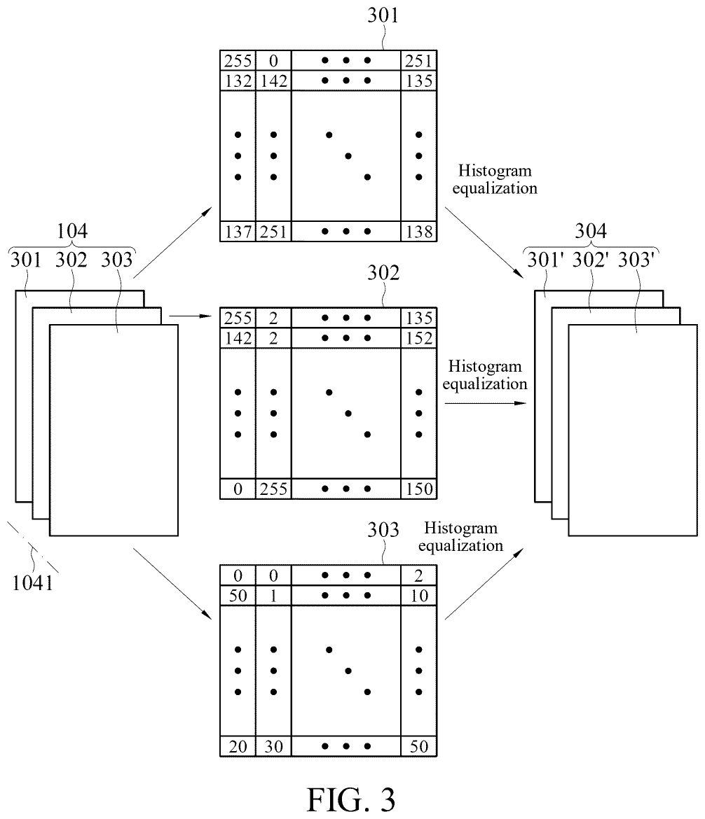

In some embodiments of the disclosure, the image 104 is a color image, and the above pre-processing procedure includes: carrying out histogram equalization on each of a plurality of image tensors on a color channel of the image 104. FIG. 3 is a diagram of histogram equalization according to some embodiments of the disclosure. In FIG. 3, the image 104 has an image tensor 301, an image tensor 302 and an image tensor 303 on a color channel 1041 of the image 104. The image tensor 301 corresponds to red, the image tensor 302 corresponds to green, and the image tensor 303 corresponds to blue. The pre-processing unit 101 carries out histogram equalization on the image tensor 301, the image tensor 302 and the image tensor 303 respectively to obtain an image tensor 301′, an image tensor 302′ and an image tensor 303′ after the histogram equalization. The pre-processing unit 101 combines the image tensor 301′, the image tensor 302′ and the image tensor 303′ after the histogram equalization into an image 304 as the pre-processed image of the image 104.

It is worth noting that in the above pre-processing procedure, adaptive histogram equalization (AHE) or contrast limited AHE (CLAHE) may also be used to process the image 104 to obtain the pre-processed image.

FIG. 9 is a flowchart of a depth image computation procedure according to some embodiments of the disclosure. In the example shown in FIG. 9, the depth image generating unit 102 uses a depth estimation neural network to obtain the depth image. The above depth image computation procedure includes step S901 to step S903. In step S901, the depth image generating unit 102 generates an input image based on the pre-processed image of the image 104. The size of the input image conforms to the input image size of the depth estimation neural network. For example, if the input image size of the depth image generating unit 102 is 255 pixels wide and 160 pixels high, then the depth image generating unit 102 scales the pre-processed image into the above input image size of the depth image generating unit 102 to generate the input image.

In step S902, the depth image generating unit 102 inputs the input image into the depth estimation neural network to obtain an intermediate depth image from the output of the depth estimation neural network. The depth value of each pixel of the intermediate depth image represents the relative depth estimation value of the corresponding pixel in the input image. In this example, a larger depth value of the pixel of the intermediate depth image indicates a smaller depth, i.e., a shorter estimated distance from the lens.

The depth values of the pixels in the intermediate depth image are distributed between 0 and the maximum floating-point number of the calculator. Therefore, in order to make the depth values of the pixels in the intermediate depth image distributed within a fixed range, in step S903, the depth image generating unit 102 normalizes the above intermediate depth image to obtain the depth image. The depth value of each pixel of the depth image falls between 0 and a maximum range value. The above maximum range value is, for example, 255.

Of course, the above depth estimation neural network may also use other monocular depth estimation models. The above monocular depth estimation model is, for example, deep ordinal regression network (DORN), DenseDepth, dense prediction transformers (DPT), dense prediction transformers (GLPN) or Marigold. DORN and DenseDepth are models established using convolutional neural networks, DPT and GLPN are transformer-based models, and Marigold is a diffusion-based model.

In some embodiments of the disclosure, the above normalizing the intermediate depth image to obtain the depth image includes a first step and a second step. In the first step, the depth image generating unit 102 obtains a maximum depth value and a minimum depth value of the intermediate depth image from the depth values of all the pixels of the intermediate depth image. In the second step, the depth image generating unit 102 subtracts the minimum depth value from each depth value of the intermediate depth image and multiplies the difference by a ratio. The above ratio is a preset maximum range value divided by a difference between the maximum depth value and the minimum depth value. The above first step and the above second step may be represented by tensor operations. If DepthMapᵢₙₜₑᵣ is made to represent the image tensor of the intermediate depth image, DepthMap is made to represent the image tensor of the depth image, min(DepthMapᵢₙₜₑᵣ) is made to represent the minimum depth value among the depth values of all the pixels of the intermediate depth image and max(DepthMapᵢₙₜₑᵣ) is made to represent the maximum depth value among the depth values of all the pixels of the intermediate depth image, then

$$DepthMap = \frac{( {DepthMap}_{inter} - min ( {DepthMap}_{inter} ) )}{max ( {DepthMap}_{inter} ) - min ( {DepthMap}_{inter} )} * maximum range value . \qquad ( Equation 1 )$$

After the above first step and the above second step, the intermediate depth image is normalized into the depth image. The depth value of each pixel of the depth image falls between 0 and the maximum range value. It is worth noting that in the above example, the intermediate depth image is normalized using Equation 1. However, the intermediate depth image may also be normalized using other methods, and the disclosure is not limited to the method described in the above first step and the above second step.

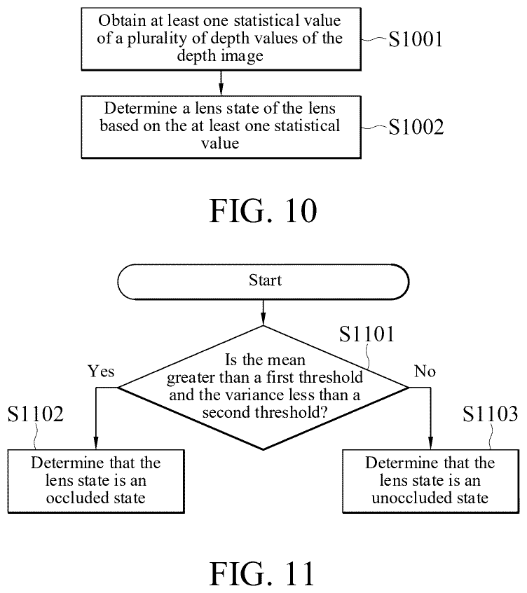

FIG. 10 is a flowchart of the occlusion judgment method according to some embodiments of the disclosure. Referring to FIG. 8 and FIG. 10 together, in the example of FIG. 10, the above step S803 includes step S1001 to step S1002. In step S1001, the judgment unit 103 obtains at least one statistical value of a plurality of depth values of the depth image. In step S1002, the judgment unit 103 determines a lens state of the lens based on the obtained at least one statistical value. The lens state of the lens includes an occluded state and an unoccluded state.

FIG. 11 is a flowchart of the occlusion judgment method according to some embodiments of the disclosure. Referring to FIG. 8, FIG. 10 and FIG. 11 together, in the example of FIG. 11, a larger depth value of the pixel of the depth image indicates a smaller depth, i.e., a shorter estimated distance from the lens. The at least one statistical value of the depth values of the depth image includes a mean and a variance of the depth values of the depth image. The above Step S1002 includes step S1101 to step S1103. In step S1101, the judgment unit 103 determines whether the mean of the depth values of the depth image is greater than a first threshold and whether the variance of the depth values of the depth image is less than a second threshold. If the judgment unit 103 determines that the mean is greater than the first threshold and the variance is less than the second threshold, then the process goes to step S1102. If not (i.e., the mean is not greater than the first threshold or the variance is not less than the second threshold), then the process goes to step S1103.

In step S1102, the judgment unit 103 determines, in response to the mean being greater than the first threshold and the variance being less than the second threshold, that the lens state is the occluded state. In step S1003, it is determined, in response to the mean being not greater than the first threshold or the variance being not less than the second threshold, that the lens state is the unoccluded state.

In the above embodiment, the judgment unit 103 uses the mean and the variance of the depth values of the depth image as judgment criteria, which can reduce misjudgment in a low light source environment. However, it is worth noting that although the judgment unit 103 uses the mean and the variance of the depth values of the depth image as judgment criteria in the above example, the judgment unit 103 may also use other statistical values of the depth values of the depth image as the judgment criteria. In some embodiments of the disclosure, the judgment unit 103 uses the mean and the standard deviation of the depth values of the depth image as the judgment criteria.

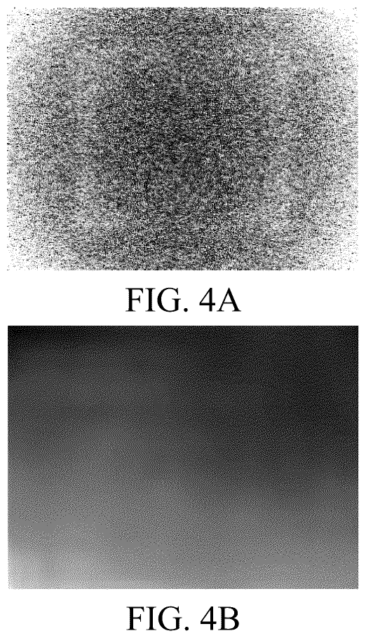

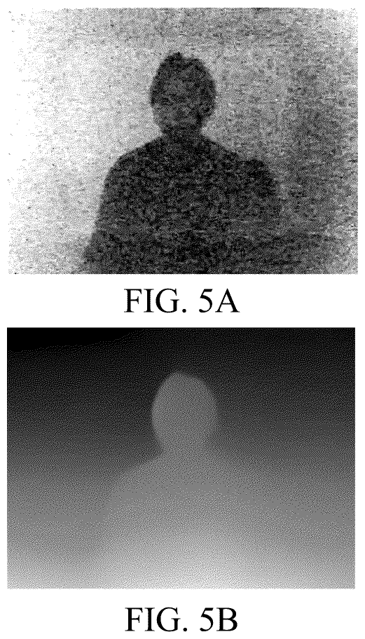

FIG. 4A and FIG. 5A are diagrams of pre-processed images according to some embodiments of the disclosure. FIG. 4B and FIG. 5B are diagrams of depth images according to some embodiments of the disclosure. Referring to FIG. 4A to FIG. 4B, FIG. 5A to FIG. 5B and FIG. 9 to FIG. 11, in some embodiments of the disclosure, FIG. 4A shows a pre-processed image, FIG. 4B shows a depth image corresponding to FIG. 4A, FIG. 5A shows another pre-processed image, and FIG. 5B shows a depth image corresponding to FIG. 5A. The above first threshold is 30, and the above second threshold is 150. The individual means and variances of the depth values of FIG. 4B and FIG. 5B are shown in Table I:

TABLE I

| | Mean | Variance |
|---|---|---|
| FIG. 4B | 48.6167 | 115.7676 |
| FIG. 5B | 22.1757 | 214.2138 |

For FIG. 4B, the judgment unit 103 determines that the mean (48.6167) of the depth values of FIG. 4B is greater than the first threshold (30) and the variance (115.7676) of the depth values of FIG. 4B is less than the second threshold (150), so the judgment unit 103 determines that the lens state corresponding to FIG. 4B is the occluded state. For FIG. 5B, the judgment unit 103 determines that the mean (22.1757) of the depth values of FIG. 5B is not greater than the first threshold (30), so the judgment unit 103 directly determines the lens state corresponding to FIG. 5B is the unoccluded state.

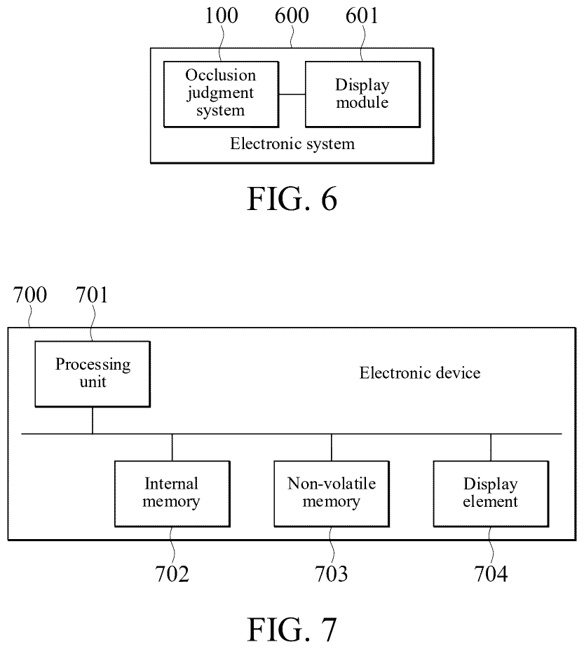

FIG. 6 is a block diagram of an electronic system according to some embodiments of the disclosure. Referring to FIG. 6, the electronic system 600 includes an occlusion judgment system 100 and a display module 601. The display module 601 controls a display screen. In this example, the occlusion judgment method further includes: the judgment unit 103 sends, in response to the obtained lens state of the lens being an occluded state, a judgment signal to the display module 601. After receiving the judgment signal, the display module 601 controls the display screen to display a prompt image. The above prompt image may include a graphic or text warning that the lens state is the occluded state.

FIG. 7 is a structural diagram of an electronic device according to some embodiments of the disclosure. As shown in FIG. 7, on the hardware level, the electronic device 700 includes a processing unit 701, an internal memory 702, a non-volatile memory 703 and a display element 704. The internal memory 702 is, for example, a random-access memory (RAM). The non-volatile memory 703 is, for example, at least 1 disc memory. The display element 704 includes the above display screen. The display element 704 is, for example, a liquid crystal display, a plasma display, a computer display (for example, a variable graphics array (VGA) display, a super VGA display and a cathode-ray tube display) and other similar types of display apparatuses, but is not limited thereto. Of course, the electronic device 700 may further include hardware required for other functions.

The internal memory 702 and the non-volatile memory 703 are configured to store programs, which may include program codes, including computer operation instructions. The internal memory 702 and the non-volatile memory 703 provide instructions and data to the processing unit 701. The processing unit 701 reads a corresponding computer program from the non-volatile memory 703 to the internal memory 702 and then runs it, and forms the pre-processing unit 101, the depth image generating unit 102 and the judgment unit 103 of the occlusion judgment system 100 on the logical level to perform the steps described in FIG. 8 to FIG. 11. Of course, the modules of the occlusion judgment system 100 may also be implemented in hardware, which is not limited in the disclosure.

The processing unit 701 may be an integrated circuit chip having signal processing capabilities. In the implementation process, the methods and steps disclosed in the above embodiments can be completed by means of an integrated logic circuit of hardware in the processing unit 701 or instructions in the form of software. The processing unit 701 may be a general-purpose processor including a central processing unit (CPU), a tensor processing unit, a digital signal processor (DSP), an application specific integrated circuit (ASIC), a field-programmable gate array (FPGA) or other programmable logic apparatuses, which can implement or perform the methods and steps disclosed in the above embodiments.

Examples of computer storage media include, but not limited to, a phase-change random access memory (PRAM), a static random access memory (SRAM), a dynamic random access memory (DRAM), other types of random access memories (RAMs), a read-only memory (ROM), an electrically erasable programmable read-only memory (EEPROM), a flash memory or other internal memory technologies, a compact disc read-only memory (CD-ROM), a digital versatile disc (DVD) or other optical storages, a magnetic cassette tape, a magnetic tape disc storage or other magnetic storage devices, or any other non-transmission media, which can be used for storing information that can be accessed by computing devices. As defined herein, computer readable media do not include transitory media, such as modulated data signals and carriers.

Based on the above, some embodiments of the disclosure provide the occlusion judgment system, the occlusion judgment method, the computer readable recording medium with a stored program, and the non-transitory computer program product. The lens state of the lens is determined through the depth image of the pre-processed image. Since the depth image varies greatly in different environments, the lens state in a dark environment can be effectively prevented from being misjudged as an occluded state, so that the lens state can be determined more accurately.

Although the disclosure has been described in considerable detail with reference to certain preferred embodiments thereof, the disclosure is not for limiting the scope of the invention. Persons having ordinary skill in the art may make various modifications and changes without departing from the scope and spirit of the disclosure. Therefore, the scope of the appended claims should not be limited to the description of the preferred embodiments described above.

What is claimed is:

1. An occlusion judgment system, comprising:
a pre-processing unit, configured to receive an image from a lens and perform a pre-processing procedure on the image to obtain a pre-processed image;
a depth image generating unit, configured to perform a depth image computation procedure on the pre-processed image to obtain a depth image; and
a judgment unit, configured to determine a lens state of the lens based on the depth image.

2. The occlusion judgment system according to claim 1, wherein the image is a grayscale image, and the pre-processing procedure comprises: carrying out histogram equalization on the image.

3. The occlusion judgment system according to claim 1, wherein the image is a color image, and the pre-processing procedure comprises: carrying out histogram equalization on each of a plurality of image tensors on a color channel of the image.

4. The occlusion judgment system according to claim 1, wherein the depth image computation procedure comprises:
generating an input image based on the pre-processed image;
inputting the input image to a depth estimation neural network to obtain an intermediate depth image; and
normalizing the intermediate depth image to obtain the depth image.

5. The occlusion judgment system according to claim 4, wherein the normalizing the intermediate depth image to obtain the depth image comprises:
obtaining a maximum depth value and a minimum depth value of the intermediate depth image; and
subtracting the minimum depth value from each depth value of the intermediate depth image and multiplying the difference by a ratio, wherein the ratio is a maximum range value divided by a difference between the maximum depth value and the minimum depth value.

6. The occlusion judgment system according to claim 1, wherein the step of the determining the lens state of the lens based on the depth image comprises:
obtaining at least one statistical value of a plurality of depth values of the depth image; and
determining the lens state of the lens based on the at least one statistical value.

7. The occlusion judgment system according to claim 6, wherein the at least one statistical value of the depth values of the depth image comprises a mean and a variance of the depth values of the depth image; and the determining the lens state of the lens based on the at least one statistical value comprises:
determining, in response to the mean being greater than a first threshold and the variance being less than a second threshold, that the lens state is an occluded state; and
determining, in response to the mean being not greater than the first threshold or the variance being not less than the second threshold, that the lens state is an unoccluded state.

8. The occlusion judgment system according to claim 1, wherein the judgment unit is configured to: send, in response to the lens state of the lens obtained being an occluded state, a judgment signal to a display module to control a display screen to display a prompt image.

9. An occlusion judgment method, comprising
receiving, by a pre-processing unit, an image from a lens, and performing a pre-processing procedure on the image to obtain a pre-processed image;
performing, by a depth image generating unit, a depth image computation procedure on the pre-processed image to obtain a depth image; and
determining, by a judgment unit, a lens state of the lens based on the depth image.

10. The occlusion judgment method according to claim 9, wherein the image is a grayscale image, and the pre-processing procedure comprises: carrying out histogram equalization on the image.

11. The occlusion judgment method according to claim 9, wherein the image is a color image, and the pre-processing procedure comprises: carrying out histogram equalization on each of a plurality of image tensors on a color channel of the image.

12. The occlusion judgment method according to claim 9, wherein the depth image computation procedure comprises:
generating an input image based on the pre-processed image;
inputting the input image to a depth estimation neural network to obtain an intermediate depth image; and
normalizing the intermediate depth image to obtain the depth image.

13. The occlusion judgment method according to claim 12, wherein the normalizing the intermediate depth image to obtain the depth image comprises:
obtaining a maximum depth value and a minimum depth value of the intermediate depth image; and
subtracting the minimum depth value from each depth value of the intermediate depth image and multiplying the difference by a ratio, wherein the ratio is a maximum range value divided by a difference between the maximum depth value and the minimum depth value.

14. The occlusion judgment method according to claim 9, wherein the determining the lens state of the lens based on the depth image comprises:
obtaining at least one statistical value of a plurality of depth values of the depth image; and
determining the lens state of the lens based on the at least one statistical value.

15. The occlusion judgment method according to claim 14, wherein the at least one statistical value of the depth values of the depth image comprises a mean and a variance of the depth values of the depth image; and the step of the determining the lens state of the lens based on the at least one statistical value comprises:
determining, in response to the mean being greater than a first threshold and the variance being less than a second threshold, that the lens state is an occluded state; and
determining, in response to the mean being not greater than the first threshold or the variance being not less than the second threshold, that the lens state is an unoccluded state.

16. The occlusion judgment method according to claim 9, wherein the occlusion judgment method comprises: sending, by the judgment unit, in response to the lens state of the lens obtained being an occluded state, a judgment signal to a display module to control a display screen to display a prompt image.

17. A computer readable recording medium with a stored program, wherein a processing unit, after loading and executing the stored program, completes the method according to claim 9.

18. A non-transitory computer program product, storing at least one instruction which, when executed by a processing unit, causes the processing unit to perform the method according to claim 9.
